(19) United States
(12) Patent Application Publication
(10) Pub. No.: US 2008/0291676 A1
(43) Pub. Date: Nov. 27, 2008

(54) SIMULATED HOLIDAY LIGHT DISPLAYS AND METHOD OF HOLIDAY DECORATING USING SAME

(76) Inventor: William M. Keneman, Las Vegas, NV (US)

Correspondence Address: WEISS & MOY PC, 4204 NORTH BROWN AVENUE, SCOTTSDALE, AZ, 85251, US

(21) Appl. No.: 11/751,167

(22) Filed: May 21, 2007

(51) Int. Cl. F21V 21/00

(52) U.S. Cl. 362/249

(57) ABSTRACT

A simulated holiday light display is provided. The simulated holiday light display includes one or more model buildings decorated and designed in any style with a plurality of first and second openings in the walls of the one or more model building, and a light source within the model building. Simulated holiday lights such as translucent beads or the like are received in at least a portion of the plurality of first openings. The plurality of second openings appears as window openings. When illuminated, the light from within the model building shines exteriorly of the model building though the simulated holiday lights and the window openings to create the appearance of a home or business that has been decorated with holiday lights, including Christmas string lights. Changing the color, design, placement of the simulated holiday lights changes the holiday light design on the simulated holiday light display.

### FIELD OF THE INVENTION

This invention relates generally to holiday decorations. More specifically, this invention relates to simulated holiday light displays.

### BACKGROUND OF THE INVENTION

Holiday decorations are a multimillion dollar industry. Many types of decorations exist. Lighted holiday decorations for homes and businesses are particularly popular. Holiday light displays are a sure way to enliven ones home or business for the holidays. Exterior light displays are especially popular. The building exterior serves as an expansive design surface on which holiday celebrants may exercise their creativity.

A common holiday light display uses holiday light strings that are strung on the outside trim of the building, trim around a window frame, eaves, and shrubbery. Many types of holiday light strings are available. For example, there are conventional mini-lights, icicle lights, and mesh-style light strings. There are also holiday lights in the form of holiday shapes that may be placed on the exterior design surface of the home or business. Exemplary holiday shapes include twinkling Pumpkins for Halloween, waving Santas, reindeer, snowmen or the like for a winter holiday wonderland during Christmas, a menorah for Hanukah, etc. Some holiday light displays are very elaborate with intricate design features with major wattage.

People may choose clear, white, or multicolored holiday lights, the colors of which are typically associated with the holiday. For example, “Christmas colors” are typically red, green. Hanukah colors may be blue and white and so on. The holiday lights may be of different motion styles (e.g. Chase, Flash, Twinkle, Cycle (cycles through twinkle, flash & fade) blinking, stay lit, chase, twinkle, cycle through different settings, etc.) and different speeds. The right pattern, color and style of the holiday lights for the home and business depends upon the look desired and budget, as well as the energy requirements for the lights.

Unfortunately, hanging outdoor holiday lights on the exterior of ones home and business can be less than a cheerful experience and even dangerous, particularly when faced with a teetering ladder and tangles of light strings that do not work. If the weather is cold or snow is on the ground, the job becomes even more complicated and dangerous. Moreover, decorating a home and business with holiday lights can be a major expense as well as time intensive in both putting up and taking down the holiday lights.

Many indoor holiday decorations depict holiday scenes, but not with holiday lighting that simulates outdoor holiday lights. Many celebrants may have a miniature house or houses (including a village plurality) decorated in the style of a holiday. None of these houses depict the holiday season wherein holiday lights are strung on the displays themselves. If a holiday scene is to be depicted, then the decorations should be as people decorate their own homes and businesses. Different faiths could be accommodated by having their choice of decorations brightly displayed on the holiday houses.

There is therefore a need for novel simulated holiday light displays that simulate holiday light displays on the exterior surfaces of homes and businesses. There is also a need for simulated holiday light displays that are substantially inexpensive and safe. There is a still further need for a simulated holiday light display that may be treasured for years. The present invention fulfills these needs and provides other related advantages.

### SUMMARY OF THE INVENTION

The present invention resides in a simulated holiday light display reflects the holiday season which may be treasured for years without endangering oneself hanging holiday lights on the exterior surface of one's home or business and without incurring great expense in time and money. The simulated holiday light display comprises, generally, at least one model building with a plurality of first and second openings therein, a plurality of simulated holiday lights received in at least a portion of the plurality of first openings, and lighting means disposed within the at least one model building for shining light through the plurality of simulated holiday lights and the plurality of second openings.

In a preferred form of the invention, the model building may be of any type of structure and in any type of style. The exterior of the model building may be designed, and decorated (including painting) in any manner to simulate a full-size building. The model building may be downwardly open to define a hollow interior.

The first and second openings may be formed in the walls, roof eaves, or any exterior surface of the model building. The plurality of first openings may be provided in a substantially straight line, a curved line, or in some other design pattern. The size of the plurality of first openings may be dimensioned such that the simulated holiday light will fit within a first opening without falling backward toward the interior of the model building with the size of the plurality of first openings smaller than the size of the individual simulated holiday lights but still permit passage of light therethrough into the simulated holiday light. The plurality of first openings permit light from the light source to shine from the interior of the model building through the simulated holiday lights to the exterior of the model building.

The second openings are window openings that resemble a window in appearance or an opening in the wall of a building. The window openings permit the light from the light source to shine from the interior of the model building through the window openings to the exterior of the model building.

The simulated holiday lights may be translucent beads, crystals, stones or the like. The simulated holiday lights may be individual or arranged on a strand of flexible wire, string or the like at a pre-selected spacing to simulate the conventional use of holiday light strings on the exterior surface of one's home or business. The simulated holiday lights may be individually affixed in at least a portion of the plurality of first openings. If the simulated holiday lights are arranged on a strand, all or some of the simulated holiday lights may be affixed in at least a portion of the plurality of first openings. The simulated holiday lights may be of any color, shape or style.

The lighting means comprises a light source connected to power means. The light source may be an incandescent bulb or the like connected by an electric cord to a plug. The electric cord may pass through a channel in the base or rear wall to extend exteriorly and rearwardly of the model building to plug into a receptacle. If the holiday light display comprises a plurality of model buildings, each model building may have its own light source attached in line with the electric cord.

In the method of holiday decorating with the model building with simulated holiday lights, the method comprises the steps of providing the model building having the plurality of first and second openings; inserting a plurality of simulated holiday lights into at least a portion of the plurality of first openings; providing a light source within the model building to provide a simulated holiday light decoration; and illuminating the simulated holiday light decoration by turning on the light source such that the light source shines out of the model building through the plurality of simulated holiday lights and the plurality of second openings.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a front perspective view of an exemplary model house embodying the invention, illustrating the front wall and one sidewall of the exemplary model house with a plurality of simulated holiday lights and a plurality of window openings through which light from a light source (not shown) within the exemplary model house shines;

FIG. 2 is a rear perspective view of the exemplary model house, illustrating the sidewall and the rear wall of the house, an electric cord from the light source passing through a channel in a base of the exemplary model house;

FIG. 3 is an elevational view of the sidewall of the exemplary model house of FIG. 1, the other sidewall (not shown) substantially identical to the sidewall of FIG. 1;

FIG. 4 is an exemplary string of simulated holiday lights, the cross-hatching showing different exemplary colors of the simulated holiday lights;

FIG. 5 is a bottom view of the exemplary model house of FIGS. 1-3 with the channel in the base permitting the electric cord to pass therethrough, illustrating a plurality of model buildings attached in line with the electric cord;

FIG. 6 is a horizontal sectional view of the sidewall of FIG. 3 taken generally along the line 6-6, illustrating a simulated holiday light at the exterior of a first opening in the sidewall;

FIG. 6A is a view similar to FIG. 6, illustrating placement of the simulated holiday light into a first opening.

### DETAILED DESCRIPTION OF THE PREFERRED EMBODIMENTS

As shown in the drawings for purposes of illustration, the present invention is concerned with a simulated holiday light display, generally designated in the accompanying drawings by the reference number 10. The simulated holiday light display comprises, generally, at least one model building 12 with a plurality of first and second openings therein 14 and 16, a plurality of simulated holiday lights 18 received in at least a portion of the plurality of first openings 14, and a light source 20 disposed within the at least one model building for shining light through the plurality of simulated holiday lights 18 and the plurality of second openings 16.

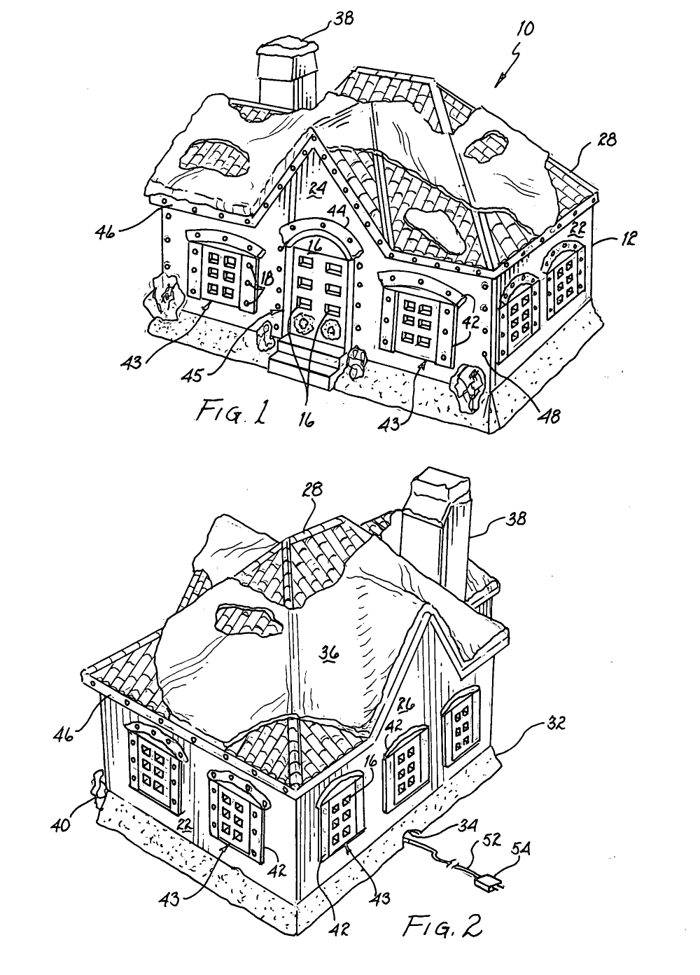

In accordance with the present invention, and as illustrated with respect to a preferred embodiment in FIGS. 1 through 6A, the simulated holiday light display reflects the holiday season without endangering oneself hanging holiday light strings on the exterior surface of one's home or business and without incurring great expense in time and money.

The model building 12 may be of any type of structure and in any type of style. The model building may be the structure in miniature or larger though not full scale (e.g. dollhouse for yard décor or the like). For example, a relatively small model building may measure six inches high, five inches wide and four inches deep. A larger model building may measure 3 feet high×4 feet wide×2 feet deep. It is to be appreciated, however, that substantial benefit may be achieved by the use of model buildings of other sizes. The model building comprises a pair of sidewalls 22, a front wall 24, a rear wall 26, and a top wall 28 (exemplified by a simulated roof in FIG. 1). The model building may be downwardly open to define a hollow interior (See FIG. 5). The model building may further include a base 32 for providing stability to the model building on the surface where placed. The model building with a base may be a unitary structure (FIGS. 1-3) or the base may be separate from the rest of the model building. The base may be tapered outwardly to provide additional stability for the model building. A channel 34 may be provided in the rear bottom edge of the base 32 (FIG. 2) or if there is no base, in the bottom edge of the rear wall (not shown) for purposes as hereinafter described.

The exterior of the model building may be designed, and decorated (including painting) in any manner to simulate a full-size building. The model building may be of a house, business or the like (such as a church, fire station, diner, hotels, motels, etc). The smaller model buildings may be constructed of a variety of materials such as ceramic, porcelain, wood, etc. The building may be molded or made from another process. “Ceramic” means an artifact made of hard brittle material produced from nonmetallic minerals by firing at high temperatures. “Porcelain” means ceramic ware made of a more or less translucent ceramic. The larger model buildings may be constructed of materials that are weatherproof or weather resistance and lighter than that used for the miniature model buildings. The simulated roof 28 may be simulated tile or the like.

FIGS. 1-3 illustrate an exemplary model building of a traditional house style designed and decorated to evoke feelings of a winter wonderland holiday decoration. The house includes simulated snow 36 on the roof 28, a chimney 38 and simulated landscaping 40 on the exterior of the base. Each of the sidewalls 22 (FIGS. 1-3), rear wall 26 (FIG. 2) and front wall 24 (FIG. 1) include window trim 42 to evoke simulated windows 43. The front wall 24 includes door trim 44 to evoke a simulated front door 45. The window and door trim may be painted on the exterior surface of the model building or additional building material may be added to the exterior surface of the model building. The window and door trim may be simulated shutters, molding, or the like. While a model building of a particular style and design has been described and illustrated, it is to be appreciated that a model building of any style and design may be used within the confines of the invention.

A plurality of model buildings 12 may be arranged in one simulated holiday light display (See FIG. 5). Each model building or plurality of model buildings should be inspired by the timeless tradition of the holiday. Figurines of people, horses, sleighs, park benches, trees, etc. (not shown) may be included to enhance the holiday spirit.

The first and second openings 14 and 16 may be formed in the walls of the model building during or after formation of the model building depending upon the material used for the model building. For example, in ceramic or porcelain model buildings, the first and plurality of second openings may be formed prior to the firing process. The openings may be formed by a drill or by some other known method. The first and second openings extend from the interior to the exterior of the building as shown in FIGS. 6 and 6A (first openings 14) and FIGS. 1-3 (second openings 16).

In the exemplary model building illustrated in FIG. 1, the plurality of first openings 14 is provided in the roof and side eaves 46 and 48, window trim 42, and door trim 44. It is to be appreciated that the plurality of first openings may be provided in additional portions of the model building to simulate wherever holiday light strings are conventionally strung on a home or business during a holiday season. The plurality of first openings 14 may be provided in a substantially straight line (e.g. on the roof eaves 46), a curved line (e.g. above the simulated door in the door trim 44), or in some other design pattern. They may also provide the outline for holiday symbols (not shown). For example, for the Christmas holiday, the plurality of first openings may provide the outline of a wreath, a Santa sleigh, reindeer or the like. For Hanukah, the plurality of first openings may be arranged in the pattern of a menorah, etc. Other holidays may be similarly symbolized. The size of the plurality of first openings may be dimensioned such that the simulated holiday lights 18 will fit within the first openings (See FIGS. 6 and 6A) without falling backward toward the interior 30 of the model building with the size of the plurality of first openings smaller than the size of the individual simulated holiday lights. The size of the plurality of first openings 14 and simulated holiday lights 18 may be the same or varied in one model building. Their size may be scaled to the size of the model building. For example, for a relatively small model building measuring about six inches high, five inches wide and four inches deep, the size of the individual simulated holiday lights may be in the range of about 2.5 mm to about 3 mm, preferably about 2.5 mm. For larger model buildings, the size of the plurality of first openings 14 and individual simulated holiday lights may be increased. The plurality of first openings 14 permit light from the light source 20 to shine from the interior 30 of the model building through the simulated holiday lights 18 to the exterior of the model building.

The second openings 16 may be window openings. “Window opening” is defined herein as an opening in at least one of the pair of sidewalls, front wall, and rear wall of the model building that resembles a window in appearance. As shown in FIGS. 1-3, an array of second openings 16 (window openings) are provided in the simulated windows 43 and the simulated door 45 (FIG. 1). A window opening may be defined in other portions of the model building if desired. Although the window openings shown are substantially square, in an array of two columns of three each, it is to be appreciated that the window openings may have other shapes, may be in an array of a different configuration, have different sizes or may not be in an array. The window openings permit the light from the light source to shine from the interior of the model building through the window openings to the exterior of the model building.

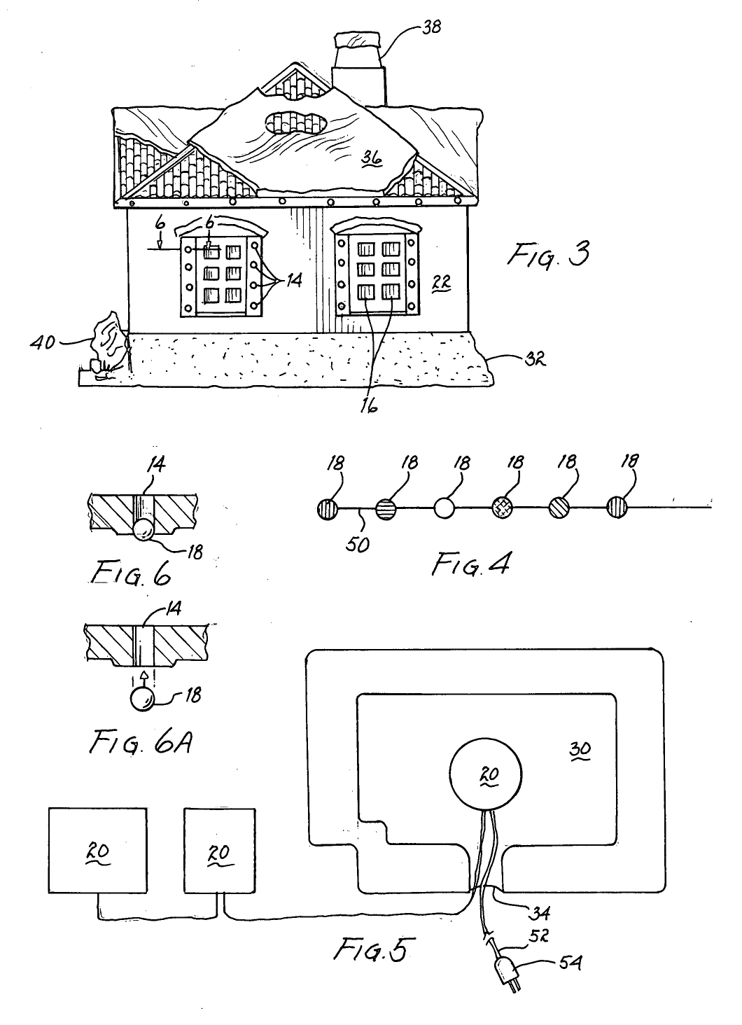

The simulated holiday lights 18 may be translucent beads, crystals, stones or the like available from craft supply stores such as Michaels Stores, Inc., Irving, Tex. or the like. The simulated holiday lights 18 may be individual or arranged on a strand 50 (FIG. 4) of flexible wire, string or the like at a pre-selected spacing to simulate the conventional use of holiday light strings on the exterior surface of one's home or business. The exemplary color scheme of the strand shown in FIG. 4 is red-blue-white-orange-green symbolizing the Christmas holiday. It is to be appreciated that other color schemes may be used that are evocative of other holidays. The simulated holiday lights may be individually affixed at the exterior surface of the model building (See FIGS. 6 and 6A) in at least a portion of the plurality of first openings. If the simulated holiday lights are arranged on a strand, all or some of the simulated holiday lights may be affixed by an adhesive or the like. The simulated holiday lights may be of any size, color, shape or style.

The light source 20 may be an incandescent bulb such as supplied from a C7 bulb, C9 bulb or the like connected by an electric cord 52 to a plug 54. The electric cord 52 may pass through the channel 34 in the base 32 (or rear wall if no base) to extend exteriorly and rearwardly of the model building as shown in FIG. 2 to plug into a receptacle (not shown). The channel 34 substantially prevents the electric cord 52 from substantially interfering with stable placement of the model building on the underlying surface. The light source 20 may have different settings for different effect to simulate the bright, dim, blinking, flashing settings of conventional holiday lights. If the simulated holiday light display 10 comprises a plurality of model buildings, each model building may have its own light source 20 attached in line with an electric cord (See FIG. 5) or by some other known method. The electric cord may include a plurality of sockets (not shown) for the light source (e.g. the C7 bulbs).

The model building may be available in a kit with the lighting system or source. The light decorations on the model building could be changed year after year depending on the color, placement and shape of the simulated holiday lights in which case a removable adhesive or the like for affixing the simulated holiday lights may be used. A model building that is a replica of one's home or business building may be available to personalize the kit.

In the method of holiday decorating with the model building with simulated holiday lights, the method comprises the steps of providing the model building 12 having the plurality of first and second openings 14 and 16; inserting a plurality of simulated holiday lights 18 into at least a portion of the plurality of first openings 14; providing a light source 20 within the model building to provide a simulated holiday light decoration; and illuminating the simulated holiday light decoration by turning on the light source such that the light source shines out of the model building through the plurality of simulated holiday lights and the plurality of second openings.

To illuminate the simulated holiday light display, an electrical receptacle (not shown) for the light source may be located. The plug may be received in the electrical receptacle (not shown). A switch-controlled receptacle may also be used or the light source may be plugged into an automatic timer (not shown) that may be set to turn the simulated holiday display on at dusk and off late at night.

From the foregoing, it is to be appreciated that the simulated holiday light display may enliven one's home or business for the holidays without endangering anybody and saving time and money year after year. The simulated holiday light day may change year after year if the simulated holiday lights are removably affixed in the first openings. The simulated light display may capture past memories that are now decorated with festive lights of the holiday season that may be treasured for years to come.

Although a particular embodiment of the invention has been described in detail for purposes of illustration, various modifications may be made without departing from the spirit and scope of the invention. Accordingly, the invention is not to be limited, except as by the appended claims.

I claim:

1. A simulated holiday light display comprising in combination
at least one model building with a plurality of first and second openings therein;
a plurality of simulated holiday lights disposed in at least a portion of the plurality of first openings at an exterior surface of the at least one model building; and
lighting means for shining light from the interior of the at least one model building through the simulated holiday lights and through the plurality of second openings.

2. The simulated holiday light display of claim 1, wherein the plurality of simulated holiday lights decorate the exterior surface of the at least one model building with holiday colors and symbols.

3. The simulated holiday light display of claim 1, wherein the at least one model building has a pair of sidewalls, a front wall, a rear wall, and a top wall.

4. The simulated holiday light display of claim 3, wherein the at least one model building further comprises a base.

5. The simulated holiday light display of claim 4, wherein a bottom edge of one of the base and rear wall has a channel for passage of an electric cord of the lighting means.

6. The simulated holiday light display of claim 3, wherein an exterior surface of at least one of the pair of sidewalls, front wall, and rear wall is decorated to define at least one simulated window and at least one simulated door.

7. The simulated holiday light display of claim 6, wherein the at least one simulated window is defined by simulated window trim and the at least one simulated door is defined by simulated door trim.

8. The simulated holiday light display of claim 6, wherein the plurality of first openings is defined through at least one of the pair of sidewalls, front wall and rear wall in simulated roof and side eaves, door trim and window trim.

9. The simulated holiday light display of claim 8, wherein the plurality of first openings are arranged in a substantially straight line in said simulated roof and side eaves, door trim and window trim.

10. The simulated holiday light display of claim 5, wherein said plurality of second openings comprise window openings through at least one of the pair of sidewalls, front wall and rear wall in the at least one simulated window and door.

11. The simulated holiday light display of claim 1, wherein the plurality of simulated holiday lights comprise individual and stranded translucent beads.

12. A simulated holiday display comprising:
at least one model building having a pair of sidewalls, a front wall, a rear wall and a roof;
at least one simulated window and simulated door decorated on an exterior surface of at least one of the pair of sidewalls, the front wall and the rear wall;
a plurality of first openings through at least one of said pair of sidewalls, said front wall, and said rear wall;
a plurality of simulated holiday lights disposed in at least a portion of said plurality of first openings at an exterior surface of the at least one model building;
at least one window opening defined through at least one of said pair of sidewalls, said front wall, and said rear wall in the at least one simulated window and simulated door; and
a light source within said at least one model building for shining light from the interior of said at least one model building out through the plurality of simulated holiday lights and the at least one window opening.

13. The simulated holiday light display of claim 12, wherein the plurality of simulated holiday lights comprise individual and stranded translucent beads.

14. The simulated holiday light display of claim 12, wherein the at least one model building further comprises a base.

15. The simulated holiday light display of claim 14, wherein a bottom edge of one of the base and rear wall has a channel for passage of an electric cord of the lighting means.

16. The simulated holiday light display of claim 12, wherein the at least one simulated window is defined by simulated window trim and the at least one simulated door is defined by simulated door trim.

17. The simulated holiday light display of claim 16, wherein the plurality of first openings is defined through at least one of the pair of sidewalls, front wall and rear wall in simulated roof and side eaves, door trim and window trim.

18. The simulated holiday light display of claim 17, wherein the plurality of first openings are arranged in a substantially straight line in said simulated roof and side eaves, door trim and window trim.

19. The simulated holiday light display of claim 12, wherein the color, placement, and style of the simulated holiday lights are changeable.

20. A method of holiday decorating with a model building with simulated holiday lights, comprising the steps of:
providing at least one model building having a plurality of first openings and a plurality of second openings through the walls thereof;
inserting a plurality of simulated holiday lights into at least a portion of the plurality of first openings at an exterior surface of said at least one model building;
providing a light source within said at least one model building;
illuminating said at least one model building by turning on the light source.

21. The method of claim 20, wherein the model building has an appearance substantially identical to his or her own home or business building.

22. The method of claim 20, further comprising the step of changing at least one of the color, placement, and style of the simulated holiday lights on the model building to change the holiday light display on the model building.
